(19) United States
(12) Patent Application Publication
(10) Pub. No.: US 2007/0094126 A1
(43) Pub. Date: Apr. 26, 2007

(54) System and method for credit account incorporating conditional teasers

(75) Inventor: Joshua B. Bufford, Glen Allen, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: CAPITAL ONE FINANCIAL CORPORATION

(21) Appl. No.: 11/259,809

(22) Filed: Oct. 26, 2005

(51) Int. Cl. G06Q 40/00

(52) U.S. Cl. 705/38

(57) ABSTRACT

Certain embodiments of the present invention are directed to credit accounts having conditional teasers. Conditional teasers include incentives offered to potential customers of the financial institution providing the credit accounts. The conditions may be related to the activity of the customers after they have established an account relationship. The activity may be, for example, the act of linking the account with another account, of the activity may be related to the spending habits of the customer. Other activities are envisioned. In certain embodiments, if the customer engages in the required activity, the teaser parameters are maintained. If not, the parameters may be eliminated or otherwise altered.

### TECHNICAL FIELD

The present invention relates generally to the field of financial services and, in particular, to a system and method for a credit account incorporating conditional teasers based on rewards conditions.

### BACKGROUND

Credit accounts are common financial service products that allow consumers to purchase goods and services without an immediate, direct exchange of cash. Instead, the credit provider that issued the credit account to the consumer, or account holder, reimburses the vendor for the account holder's purchase. In exchange, the account holder incurs debt to the credit provider that the account holder must pay off after a predetermined grace period. After the grace period, the account holder must then either pay the outstanding balance in full, or defer at least a portion of the balance to be paid at a later date and incur finance charges until the balance is paid off.

In order to attract or retain customers, credit agencies offer their account holders a variety of incentives in exchange for their business. These include cash rebates, airline miles, and discounts on purchases, among others. Credit providers also offer other incentives to attract and retain customers, such as relatively low balance-transfer rates and affinity programs.

### SUMMARY

In accordance with a particular embodiment of the present invention, a method is provided for an account having associated parameters, the parameters being subject to modification. The method includes establishing a first account for a first customer and activating a first set of parameters associated with the first account. The method also includes monitoring the activity of the first customer to make a first determination whether the activity meets at least a first requirement. The method further includes maintaining the first set of parameters if the determination is that the customer activity meets the first requirement and modifying the parameters if the first customer activity does not meet the first requirement. The first requirement is based at least partially on activity associated with a second account.

According to another embodiment, a system for managing one or more parameters of a first account includes a processor and a database coupled to the processor. The processor is operable to execute software to monitor data associated with the first account. The data indicates customer activity. The processor is further operable to determine whether the activity meets at least one requirement necessary to maintain at least one account parameter. The activity is associated with a second account.

According to another embodiment, a method is provided for an account having associated parameters, the parameters being subject to modification. The method includes establishing a first account for a first customer and activating a first set of parameters associated with the first account. The method also includes monitoring the activity of the first customer to determine whether the activity meets at least one predetermined requirement. The method further includes maintaining the first set of parameters if the determination is that the customer activity meets the at least one predetermined requirement and modifying the parameters if the first customer activity does not meet the at least one requirement. The at least one requirement is based at least partially on the first customer's spending activity associated with the first account. The spending activity has a spending volume component and a spending frequency component.

According to another embodiment, a method is provided for an account having associated parameters, the parameters being subject to modification. The method includes establishing a first account for a first customer and activating a first set of parameters associated with the first account. The method also includes monitoring the activity of the first customer to determine whether the activity meets at least one predetermined requirement. The method further includes maintaining the first set of parameters if the determination is that the customer activity meets the at least one predetermined requirement and modifying the parameters if the first customer activity does not meet the at least one requirement. The at least one requirement is based at least partially on the first customer's spending activity associated with the first account. The spending activity has a spending volume component. The spending volume component requires the first customer to use the first account to make a predetermined amount of purchases for each of at least two time periods.

According to another embodiment, a method is provided for an account having associated parameters, the parameters being subject to modification. The method includes establishing a first account for a first customer and activating a first set of parameters associated with the first account. The method also includes monitoring the activity of the first customer to determine whether the activity falls within one of a plurality of predetermined levels. The method further includes taking a first action with respect to the first set of parameters if the activity falls within a first level and taking a second action with respect to the first set of parameters if the activity falls within a second level.

A technical advantage of particular embodiments of the present invention includes the ability to attract new customers to a credit card account by providing the potential customers with an incentive.

Another technical advantage is the ability to at least partially control the benefit to new customers based on the activity of the new customers. For example, if a new customer does not do enough business with the credit provider, or conduct business according to certain standards, the incentive to the new customer may be terminated, or reduced. This has the effect of limiting, under certain circumstances, the loss the credit provider incurs by providing the incentive to the customer.

Another technical advantage is the ability to monitor, in an automated fashion, numerous credit accounts to determine customer activity and automatically modify terms of those multiple accounts. This is in contrast to prior methods which required one-on-one interaction between a financial institution and individual customers in order to establish, monitor, and change the terms of a credit account.

Another technical advantage is the ability to flexibly and automatically change the parameters by which an automated credit account system makes determinations as to the terms of credit accounts having conditional teasers. The parameters of the determination process may be changed quickly and seamlessly, thus alleviating the need for expensive, manual review and alteration of the credit account methodology employed by a financial institution.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates an example system for managing accounts in accordance with a particular embodiment of the present invention;

FIG. 2 illustrates an example system for handling transactions in which payments are made using credit cards in accordance with a particular embodiment of the present invention;

FIG. 3 illustrates an example system for managing information associated with account parameters in accordance with a particular embodiment of the present invention; and

FIG. 4 illustrates an example method for providing account parameters in accordance with a particular embodiment of the present invention.

### DETAILED DESCRIPTION

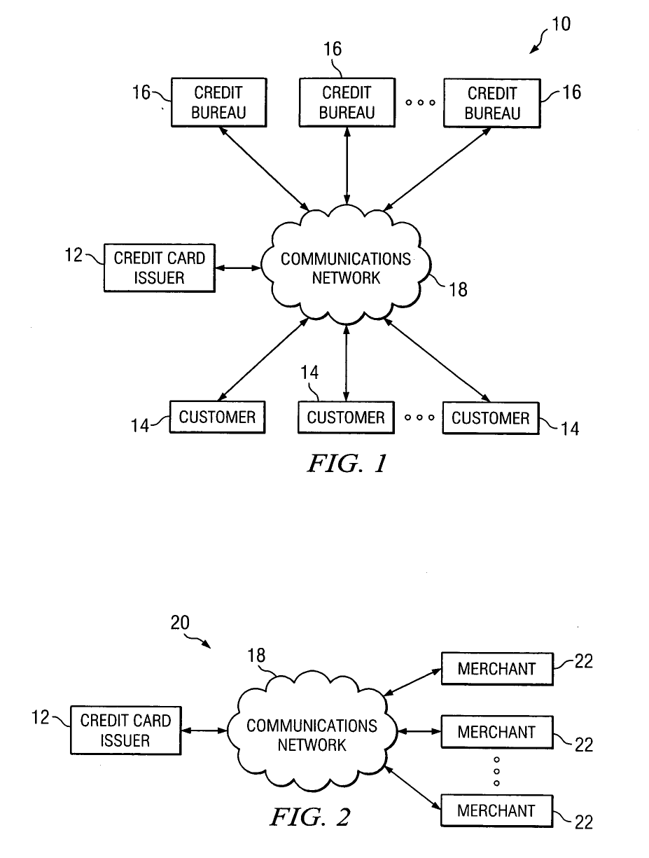

In general, certain embodiments of the present invention are directed to credit accounts having conditional teasers. Conditional teasers include incentives offered to potential customers of the financial institution providing the credit accounts. By “conditional” it is meant that the incentives are offered based on one or more conditions. The conditions can be any conditions, but generally the conditions are related to the conduct of the customers after they have established a credit account relationship with the financial institution. According to one view, the incentive is offered in exchange for the customer agreeing to abide by certain standards of conduct. The conduct may relate to any activity. In accordance with at least one embodiment, the activity relates to the customer agreeing to participate in a second account activity related to the first account (which is the conditional teaser credit account). In at least one other embodiment, the activity involves the customer agreeing to, and accomplishing, certain levels of various parameters associated with making purchases. Details regarding the provision and modification of parameters associated with the conditional teasers will be discussed in connection with FIG. 4 following a description of an example system for managing accounts and the information associated with the provision and modification of the teaser parameters, which is provided below in connection with FIGS. 1-3.

In accordance with a particular embodiment of the present invention, FIG. 1 illustrates an example system 10 for handling credit card accounts. System 10 may include a credit card issuer 12, one or more customers 14, and one or more credit bureaus 16, which may be coupled to each other by a communications network 18. Credit card issuer 12 and customers 14 may communicate with each other regarding credit card accounts using communications network 18. For example, a customer 14 may contact credit card issuer 12 using communications network 18 to open a credit card account, make inquiries or requests regarding a credit card account, make payments to credit card issuer 12, or close a credit card account. Credit card issuer 12 may similarly contact customer 14 to offer a credit card to customer 14, make inquiries regarding recent charges posted to a credit card account, or remind customer 14 of payments due. Although credit card issuer 12 and customers 14 are described as communicating with each other using communications network 18, the present invention contemplates any suitable form of communication between credit card issuer 12 and customers 14. For example, a customer 14 may contact credit card issuer 12 by telephone to make inquiries or requests regarding a credit card account or by mail to make a payment to credit card issuer 12. Similarly, credit card issuer 12 may contact a customer 14 by mail to offer a credit card to customer 14. Credit card issuer 12 may communicate with credit bureau 16 using communications network 18 to obtain credit information regarding customers 14, as described more fully below.

A customer 14 (which may also be referred to as a cardholder 14) may include an individual, a group of individuals, a business organization, or any other suitable entity to which credit card issuer 12 may issue one or more credit cards and provide one or more lines of credit. A credit bureau 16 may provide credit information to credit card issuer 12 regarding customers 14. Credit information may include credit history information, payment information, personal information regarding occupation, income, home ownership, etc., and any other suitable information. As an example only an not by way of limitation, a credit bureau 16 may include TRANS UNION, EQUIFAX, EXPERIAN, or any other suitable credit bureau. Communications network 18 may, in particular embodiments, include one or more local area networks (LANs), metropolitan area networks (MANs), wide area networks (WANs), portions of the Internet, or any other appropriate wireline, optical, wireless, or other links.

Credit card issuer 12 may include any suitable entity that issues credit cards to customers 14 and provides lines of credit (which may include revolving lines of credit) for purchases by customers 14. As an example only and not by way of limitation, credit card issuer 12 may in particular embodiments include a merchant or other bank or a credit union. Although purchases are described, the present invention contemplates any suitable transactions in which payments may be made using credit cards. For example, a customer 14 may use a credit card to rent one or more items. Credit card issuer 12 may issue any suitable credit cards. As an example and not by way of limitation, credit card issuer 12 may issue one or more MASTERCARD, VISA, DISCOVER, DINERS CLUB, JCB or other suitable credit cards. Credit cards issued by credit card issuer 12 may include general purpose credit cards (which may be used to purchase a number of different items associated with a number of different industries from a number of different merchants), private label cards (which may be used to purchase only items associated with a particular industry or items from only one or more particular merchants), or both. Although cards are particularly described, the present invention contemplates, in addition to credit card accounts having associated cards issued to customers 14, credit accounts that do not have associated cards. For example, credit card issuer 12 may open a credit account for a customer 14 having an associated credit account number but no associated card. Customer 14 may then purchase items on credit using the associated credit account number.

Reference to “credit cards” or “credit card accounts” may, where appropriate, encompass such credit accounts.

Credit card issuer 12 may handle credit card accounts, which may include opening credit card accounts for customers 14, monitoring credit card accounts, billing customers 14, receiving and handling inquiries and requests from customers 14 regarding credit card accounts, and closing credit card accounts. In particular embodiments, as described more fully below, opening a credit card account for a customer 14 may include establishing a line of credit according to credit information from credit bureau 16 regarding customer 14, information obtained from customer 14 directly, one or more evaluations of payments received from customer 14, or other suitable information, establishing one or more terms of a credit card account agreement between credit card issuer 12 and customer 14, and activating one or more services which credit card issuer 12 may provide to customer 14 in connection with the credit card account.

FIG. 2 illustrates an example system 20 for handling transactions in which payments are made using credit cards. System 20 may include credit card issuer 12 and one or more merchants 22, which may be coupled to each other by communications network 18. A merchant 22 may include any suitable entity that sells items to cardholders and may include a single entity (such as, for example, an individual store) or a number of entities (such as, for example, a chain of stores). A merchant 22 may include a seller or distributor that sells items produced by one or more otherwise unaffiliated producers. In addition or as an alternative, merchant 22 may include a producer that sells one or more items it produces directly to cardholders, bypassing distributors. Merchant 22 may include one or more outlets at one or more physical locations and may, in addition or as an alternative, include one or more call centers where phone orders are received from cardholders, one or more websites or other virtual locations where electronic orders are received from cardholders, and one or more warehouses (which may be owned by merchant 22 or owned by one or more entities separate from merchant 22 for which merchant 22 sells items to cardholders) where orders received from cardholders are filled. Payment may be made for items provided by merchant 22 using a general purpose card, private label card, or any other suitable credit card. Although merchants 22 are described as selling items to customers 14, the present invention, as described above, contemplates any suitable transactions between merchants 22 and customers 14. As an example, a merchant 22 may rent one or more items to a customer 14. As another example, a merchant 22 may provide one or more services to a customer 14.

Communications network 18 supporting communication between credit card issuer 12 and merchant 22 may include, as described above, one or more local area networks (LANs), metropolitan area networks (MANs), wide area networks (WANs), portions of the Internet, or any other appropriate wireline, optical, wireless, or other links. Communications network 18 may, where appropriate, include one or more private networks used exclusively for communication between credit card issuer 12 and one or more particular merchants 22. This may be the case where, for example, credit card issuer 12 provides lines of credit to customers 14 to purchase items only at one or more particular merchants 22. Although credit card issuer 12 and merchants 22 are described as separate entities, in particular embodiments, credit card issuer 12 and one or more merchants 22 may be part of a single, larger organization. In particular embodiments, credit card issuer 12 may include one or more merchants 22. In particular embodiments one or more merchants 22 may include credit card issuer 12.

A customer 14 may purchase items from a merchant 22 in any suitable manner. As an example, customer 14 may purchase items from merchant 22 at a store or other physical location operated by merchant 22. As another example, customer 14 may purchase items from merchant 22 over the telephone, by mail, or using the Internet or other suitable communications network (which may be similar to communications network 18), and the purchased items may be subsequently shipped to customer 14. When a customer 14 purchases one or more items from a merchant 22, merchant 22 may generate an electronic record of the transaction and communicate the generated record to credit card issuer 12. A transaction record may be generated in any suitable manner, such as at a point-of-sale terminal or other device, and may include any suitable transaction data. For example, a transaction record may include data reflecting a credit card number (or, as described above, a credit account number), data reflecting a transaction price, data identifying merchant 22, and data reflecting a transaction date. Credit card issuer 12 may use the communicated transaction record to update the credit card account of customer 14 for billing and possibly other purposes.

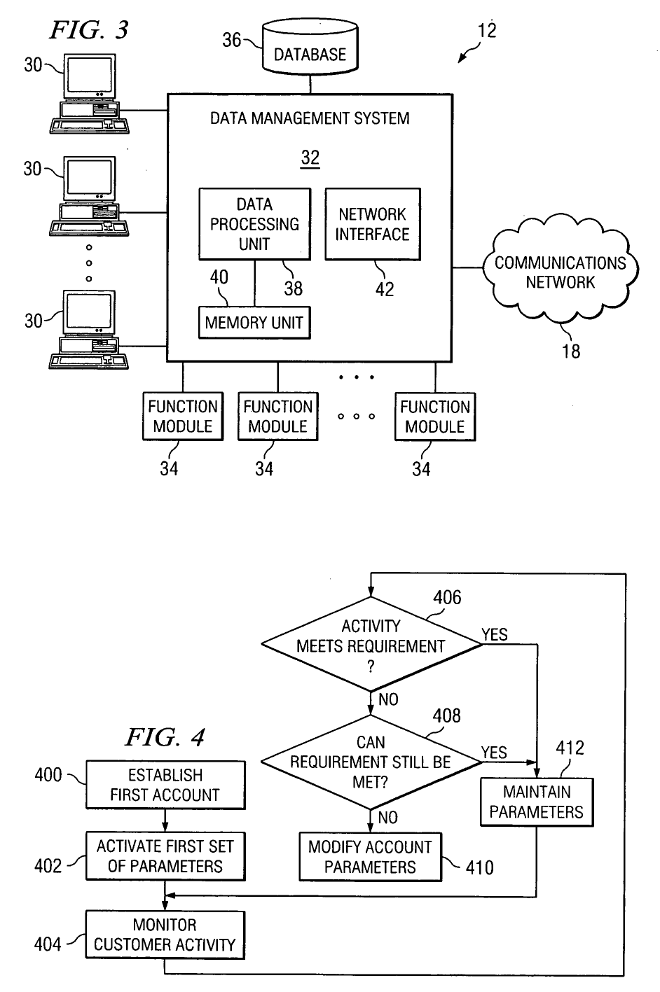

FIG. 3 illustrates an example credit card issuer 12. Credit card issuer 12 may include one or more operator terminals 30, a data management system 32, one or more function modules 34, and a database 36. The components of credit card issuer 12 may be located at a single site or, alternatively, at a number of different sites. The components of credit card issuer 12 may be coupled to each other using one or more links, each of which may include one or more computer buses, local area networks (LANs), metropolitan area networks (MANs), wide area networks (WANs), portions of the Internet, or any other appropriate wireline, optical, wireless, or other links. An operator terminal 30 may provide an operator access to data management system 32 to configure, manage, or otherwise interact with data management system 32. An operator terminal 30 may include a computer system (which may include one or more suitable input devices, output devices, processors and associated memory, mass storage media, communication interfaces, and other suitable components) or other suitable device.

Data management system 32 may manage data associated with credit card accounts, which may in particular embodiments include creating, modifying, and deleting data files associated with credit card accounts automatically or in response to data received from one or more operator terminals 30, function modules 34, or customers 14. Additionally, data management system 32 may call one or more function modules 34 to provide particular functionality according to particular needs, as described more fully below. Data management system 32 may include a data processing unit 38, a memory unit 40, a network interface 42, and any other suitable components for managing data associated with credit card accounts. The components of data management system 32 may be supported by one or more computer systems at one or more sites. One or more components of data management system 32 may be separate from other components of data management system 32, and one or more suitable components of data management system 32 may, where appropriate, be incorporated into one or more other suitable components of data management system 32.

Data processing unit 38 may process data associated with credit card accounts, which may include executing coded instructions (which may in particular embodiments be associated with one or more function modules 34). Memory unit 40 may be coupled to data processing unit 38 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors. Network interface 40 may provide an interface between data management system 32 and communications network 18 such that data management system 32 may communicate with customers 14, credit bureaus 16, and merchants 22.

A function module 34 may provide particular functionality associated with handling credit card accounts or handling transactions in which payments are made using credit cards. As an example only and not by way of limitation, a function module 34 may provide functionality associated with risk profiling, service interest, service enrollment, credit card account management, or billing. A function module 34 may be called by data management system 32 (possibly as a result of data received from an operator terminal 30 or a customer 14 via communications network 18) and, in response, provide the particular functionality associated with function module 34 and communicate one or more results to data processing unit 38 or one or more other suitable components of data management system 32, which may use the communicated results to create, modify, or delete one or more data files associated with one or more credit card accounts, provide data to an operator at operator terminal 30 or customer 14, or perform any other suitable task. Function modules 34 may be physically distributed such that each function module 34, or multiple instances of each function module 34, may be located at different sites remote from each other and possibly from data management system 32.

According to an embodiment of the invention, at least one of the function modules 34 provides a rewards condition monitoring function. As such, the module(s) monitors data associated with the accounts of customers 14 to determine whether certain conditions, relating to rewards condition parameters, are met. As will be described in greater detail below, the “rewards condition parameters” may include any suitable parameters associated with customer activity that relate to participation in a secondary account.

According to another embodiment of the invention, at least one of the function modules 34 provides a purchase condition monitoring function. As such, the module(s) monitors data associated with the accounts of customers 14 to determine whether certain conditions, relating to purchase condition parameters, are met. As will be described in greater detail below, the “purchase condition parameters” may include any suitable parameters associated with customer activity that relate to purchasing activity by the respective customer.

It should be understood that the functionality of these modules may be embodied in software, for example, or (preferably) in any suitable media for providing electronic functionality. The functionality may be provided by a single module or a combination of modules. The functionality may be centralized, decentralized, distributed, or configured in any other way so long as the features of the respective functionality are provided. The functionality may be provided, either completely or partially, by other components within, or without, the system (either shown or not). The figures provide an example configuration only.

FIG. 4 illustrates an example embodiment, according to which conditional teasers are provided, which are associated with rewards conditions. According to the illustrated method, in step 400, a first account is established having a first set of parameters. The first set of parameters may be referred to as teasers, benefits, or favorable terms and the account may be referred to as, for example, a teaser account. Other terminology may be used and still covered by the scope and spirit of this disclosure. It should be understood that the phrase “set of parameters” may mean no parameters, one parameter, or a plurality of parameters. The account may be intended as a temporary account or a permanent account. That is, the account may be temporary regardless of whether certain conditions are met, or the account may be permanent so long as certain conditions are met. Other possible scenarios are also consistent with the teachings of this disclosure.

The account may be a credit account or any suitable type of financial or other account. For example, the account may be a financial account including checking, savings, credit, and debit accounts. The account may be a service or merchandise account, such as a utilities account, food or merchandise shopping account, rental account, gas purchasing account, or otherwise.

In step 402, a first set of parameters is activated. In at least one embodiment, activation of the first set of parameters is accomplished upon the establishment of the account, whether or not the customer has met the requirements associated with the teaser parameters. In other embodiments, the first set of parameters might not be activated until the customer has met one or more of the requirements. In still other embodiments, a first set of parameters may be established (or not) and then modified as the customer meets (or fails to meet) requirements.

It should be understood that the teaser parameters may include any parameters that provide a benefit (either financially or otherwise) to a consumer. Thus, the parameters may include rewards, points, merchandise, prizes, contest entries, airline miles, rebates, etc. Teaser parameters may also include any favorable credit account terms such as lower interest rates, extended grace periods, longer billing cycles, higher credit limits, lower fees, no fees, etc. Teaser parameters may also include any ancillary services, such as reporting, identity theft prevention and forgiveness, investment notifications, etc.

In step 404, customer activity is monitored. The customer activity may include activity associated with a second account. The activity may be that of the customer of the first account or that of another customer. For example, the customer activity may be any activity associated with the first account customer's participation in a second account. As another example, the customer activity may the activity of a second customer having some predefined relationship with the first customer.

According to one aspect, the activity involves linking the first account to the second account. The activity in this example may include the act of linking the two accounts or the act of linking the two accounts within a certain time parameter. The activity may include the customer agreeing to, and accomplishing, a first set of fixed requirements associated with a linked account. Alternatively, the activity may include the customer selecting from a plurality of optional sets of requirements associated with one or more potential linked accounts.

As a specific example, a customer may establish, as the first account, a college savings account. Examples of the first set of parameters (or teasers) associated with the account may include rewards for purchases. The rewards may include, for example, a percentage rebate of all, or certain types, of purchases. The rebates may be credited to a college savings plan. Another parameter may include an interest rate that is relatively low compared to a non-teaser interest rate. Under certain circumstances, this may be referred to as a balance-transfer rate. For example, a customer that establishes the first account may receive a balance transfer rate on balances of other existing credit accounts that are transferred to the new account. Preferably, the balance transfer rate will be a rate that is lower than a standard rate on the account. The balance transfer rate may be, for example, 0% while the standard account rate is somewhere from 7%-9%.

At step 406, a determination is made whether the customer meets the requirements in order to maintain the first set of parameters. In at least one embodiment, where the first set of parameters is activated upon establishment of the first account, customer activity is monitored for a first period of time. The first period of time is preferably the amount of time by which the customer must meet the requirements necessary to maintain the benefits of the first set of parameters. However, the first period of time may be a different time period. If, during the first period of time, the customer meets the requirements, the customer will maintain the benefits of the first set of parameters at step 412. According to certain embodiments, the customer activity may continue to be monitored to determine whether a change of the parameters is warranted.

If, during the first period of time, the customer has not met the requirements, then a determination is made, at step 408, whether additional time is left for the customer to meet the requirements. If so, then the first set of parameters is maintained. If not, then (at step 410) the first set of parameters is modified.

The modified (or second set) of parameters may include any parameters associated with the terms of the first account. Alternatively the parameters may be associated with the terms of a second account. Parameters may be, for example, terms that are less favorable to the customer than the terms associated with the “teaser parameters.” For example, the credit interest rate may go up, a savings interest rate may go down, a fee may be charged, a service may be altered, the credit account may be terminated, the length of time for which favorable terms are available may be shortened, etc. Alternatively, a new set of teaser parameters may be offered with an associated new set of requirements. This may be viewed as a “second chance” for the customer to engage in the activity being promoted by the offer of teaser parameters.

In any event, once the determination has been made that the customer has not met, or cannot meet the requirements necessary for, or associated with, the first (teaser) set of parameters, a new set of parameters is established for the first account, or for another account.

The requirements may include any suitable requirements that can be associated with the maintenance of the first set of parameters and which can be monitored (either directly or indirectly) by the institution providing the first account. In at least one embodiment, as mentioned above, the activity is the act of the customer linking the first account to a second account. As with the first account, the second account may be any type of account that can be offered to the customer. Preferably, the second account is offered to the customer by the same institution offering the first account. The second account may be, for example, a financial account. In one embodiment, such as where the first account is a credit account with a favorable balance transfer rate, the second account might be a deposit or investment account. The customer may be required to link the first (e.g., credit) account to the second (e.g., investment) account during a certain period or time (e.g., six months) in order to maintain the balance transfer rate. If the customer does not link the accounts within the specified time period the interest rate on the credit account may be raised.

Customer activity can also include any activity associated with time periods. In other words, the activity may comprise any specified conduct that must take place within a certain period of time or within a certain time window. The time may be associated with the customer's age, for example, or may be a specified number of days, weeks, or months, for example.

Although linking accounts has been discussed as one type of customer activity, other types of activity may be incorporated into the requirements for establishing, or maintaining, the first set of parameters. For example, customer activity may be associated with purchasing activity related to the first account, or another account. Purchasing activity may include any purchasing parameter such as spending volume or spending frequency.

With respect to spending volume, the requirement may be that the customer spends a certain amount within a certain period of time. For example, to maintain the teaser credit account interest rate (e.g., a 0% balance transfer rate), the customer may be required to use the credit account to make $500 worth of purchases within the first six months of the establishment of the credit account. If they do, then the balance transfer rate stays at 0%. If they do not, then the balance transfer rate is increased to, for example, 9%. In an alternative embodiment, the spending volume requirement is segregated into levels, each level being associated with a different term, parameter, or value of a term or parameter. For example, if the customer spends $500 within the first six months, the customer maintains the 0% balance transfer rate. If the customer, however, spends $2,000 in the first six months, not only is the 0% balance transfer rate maintained, but the customer gets a preferred rate (say 7%) on any new purchases (or any new purchases for a certain amount of time, such as one year). If the customer does not make $500 in purchases in the first six months, but does make $500 in purchases within the first nine months, then the balance transfer rate might be raised, but to a lower rate than the standard rate (e.g., 3%). In this example, the rate might have been raised to the intermediate (3%) rate at the end of the first six months and then maintained at that rate because the customer met the spending volume requirement during the next three months. Optionally, the rate may have been increased to the standard rate (e.g., 9%) and then lowered to the intermediate rate once the customer met the spending volume within the ninth month period. As it will be understood, numerous scenarios may exist with respect to associating account parameters with customer activity, particularly where timing is also associated with the activity.

Purchasing activity can also include activity associate with spending frequency. Spending frequency refers to customer conduct relating to the frequency of purchases using the first account. The frequency of purchases does not necessarily have any relationship to the amount of purchases. However, a spending volume requirement may be combined with a spending frequency requirement (or with any other requirement). A spending frequency requirement may include any requirement associated with the number or purchases over a given period of time or the time between purchases. For instance, a customer, in order to maintain the teaser parameters associated with the first account, may be required to make a certain number of purchases within a certain time period. As an example, the customer may be required to make at least ten purchases using the account during the first six months. As an alternative, the customer may be required to make a certain number of purchases for each of multiple time periods. For example, the customer might be required to make at least three purchases each month to keep the favorable teaser rate, or the customer might be required to make at least three purchases each month for a six-month period to keep the teaser rate. As another alternative, the customer may be required to achieve a certain spending frequency (or volume), which may be required to occur within a certain time period, in order to extend the teaser rate (or other ones of the first parameters) beyond an initial activation time. For example, a customer establishing a new account might receive a balance transfer rate of 0% for the first six months. The customer then might be able to extend the 0% rate for an additional six-month period if the customer makes a certain number of purchases within the first six months, or makes a certain number of purchases during each of a plurality of sub-periods within the first six months, or spends a certain amount within the first six months or sub-periods of the first six months. It should be understood that numerous variations and combinations of requirements may be utilized within the teachings of this description.

Other types of customer behavior or activity can be monitored and used as the basis for altering the initial parameter of the first account (or of any other associated account). For example, modification of parameters may be based on payment performance of the customer. For example, the customer might be required to make each payment on time for each billing cycle in order to maintain the teaser parameters. As an alternative, if the customer pays early for each billing cycle, or for a number of billing cycles, then the customer might be rewarded with additional teasers or improved parameters. As another alternative, the customer may be required to establish a direct deposit for the account in order to maintain (or improve) the teaser parameters. In other embodiments any suitable activity that generates a certain predetermined profit may be used as the basis for determining whether the teaser parameters should be improved, reduced, or maintained.

Other types of activity can include, but are not limited to: transaction volume, number of transactions, frequency of transactions, size of transactions, transaction types, payment diligence, balance transfers, payment volume, revolving balances, registering rewards accounts, opening a deposit or investment account, and/or opening an authorized user card with an associated spending behavior, etc.

As indicated previously, it should be understood that the activity may be used as the basis for maintaining teaser parameters that have already been activated. Optionally, the activity may be required before the parameters are activated. In other words, once the customer engages in the required activity, the teaser parameters are activated. It should be understood that this may occur some time after establishing the first account. Also, teaser parameters (or other parameters) may be activated, de-activated, modified, reduced, increased, improved, or otherwise modified a plurality of times during the life of the associated account. For example, teaser parameters may be activated when the account is first opened, then deactivated when the customer does not meet the requirements by a certain time, then reactivated when the customer meets the requirements (or some alternate requirements, such as the payment of a fee) sometime after the first time period.

According to certain embodiments, the teaser parameters are determined according to categories or levels of customer activity. For example, if the customer activity falls within one level, then the parameters are modified in a first manner. If the customer activity falls within a second level, different from the first level, the parameters are modified in a second manner different from the first manner. It should be understood that “modified” may mean any modification including, without limitation maintaining, no change, reducing, increasing, establishing, or eliminating one or more of the teaser parameters. Thus, for example, if a customer spends $100 during the first three months, the 0% rate may be maintained for an additional six month period beyond an introductory six-month period. If, however, the customer reaches a second level of activity (e.g., by making $500 worth of purchases in the first three months, then the 0% account rate might be maintained for a year beyond the initial six-month introductory period. This is a specific example only and numerous scenarios are possible. Other examples may impact different types of accounts, different customers, different parameters, etc., each being caused by the different levels of activity engaged in by the first customer.

Although particular embodiments of the systems and methods of the present invention have been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method for providing an account having associated parameters, the parameters being subject to modification, the method comprising:
establishing a first account for a first customer;
activating a first set of parameters associated with the first account;
monitoring the activity of the first customer to make a first determination whether the activity meets at least a first requirement;
maintaining the first set of parameters if the determination is that the customer activity meets the first requirement and modifying the parameters if the first customer activity does not meet the first requirement, wherein the first requirement is based at least partially on activity associated with a second account.

2. The method of claim 1, wherein the first set of parameters is activated before the first determination of whether the activity meets the first requirement.

3. The method of claim 1, wherein the first set of parameters is activated after the first determination of whether the activity meets the first requirement.

4. The method of claim 1, wherein the first set of parameters comprises at least one teaser parameter.

5. The method of claim 4, wherein the at least one teaser parameter is an introductory credit account interest rate.

6. The method of claim 4, wherein the at least one teaser parameter is a balance transfer rate.

7. The method of claim 4, wherein the at least one teaser parameter is a rewards criterion.

8. The method of claim 1, wherein the first account is a credit account.

9. The method of claim 8, wherein the credit account has an associated rewards program.

10. The method of claim 1, wherein the first account is a savings account.

11. The method of claim 1, wherein the first account is an investment account.

12. The method of claim 1, wherein the first account is a debit account.

13. The method of claim 1, further comprising making a second determination of whether the customer activity meets the first requirement.

14. The method of claim 13, wherein the second determination is made after the first determination and if the first determination is that the customer activity does not meet the first requirement.

15. The method of claim 1, further comprising making a second determination of whether the customer activity meets at least a second requirement.

16. The method of claim 1, wherein a plurality of the first set of parameters is modified based at least partially on the first determination.

17. The method of claim 1, wherein the customer activity comprises the establishment of the second account.

18. The method of claim 1, wherein the customer activity comprises linking the first account to the second account.

19. The method of claim 1, wherein the customer activity comprises the first customer's spending activity associated with the second account.

20. The method of claim 1, wherein the customer activity comprises activity of the first customer.

21. The method of claim 1, wherein the customer activity comprises activity of a second customer.

22. The method of claim 21, wherein the second customer has a predefined association with the first customer.

23. The method of claim 22, wherein the association is a family relationship.

24. The method of claim 22, wherein the association is a sponsorship.

25. The method of claim 22, wherein the association is a business relationship.

26. The method of claim 1, wherein the at least a first a requirement comprises at least two requirements, one of the at least two requirements being associated with the first account and one of the at least two requirements being associated with the second account.

27. A system for managing one or more parameters of a first account, the system comprising:
a processor; and
a database coupled to the processor,
the processor operable to execute software to monitor data associated with the first account, the data indicating customer activity, the processor further operable to determine whether the activity meets at least one requirement necessary to maintain at least one account parameter, the activity being associated with a second account.

28. A method for providing an account having associated parameters, the parameters being subject to modification, the method comprising:
establishing a first account for a first customer;
activating a first set of parameters associated with the first account;
monitoring the activity of the first customer to determine whether the activity meets at least one predetermined requirement;
maintaining the first set of parameters if the determination is that the customer activity meets the at least one predetermined requirement and modifying the parameters if the first customer activity does not meet the at least one requirement, wherein the at least one requirement is based at least partially on the first customer's spending activity associated with the first account, wherein the spending activity has a spending volume component and a spending frequency component.

29. A method for providing an account having associated parameters, the parameters being subject to modification, the method comprising:
establishing a first account for a first customer;
activating a first set of parameters associated with the first account;
monitoring the activity of the first customer to determine whether the activity meets at least one predetermined requirement;
maintaining the first set of parameters if the determination is that the customer activity meets the at least one predetermined requirement and modifying the parameters if the first customer activity does not meet the at least one requirement, wherein the at least one requirement is based at least partially on the first customer's spending activity associated with the first account, wherein the spending activity has a spending volume component, the spending volume component requiring the first customer to use the first account to make a predetermined amount of purchases for each of at least two time periods.

30. A method for providing an account having associated parameters, the parameters being subject to modification, the method comprising:
establishing a first account for a first customer;
activating a first set of parameters associated with the first account;
monitoring the activity of the first customer to determine whether the activity falls within one of a plurality of predetermined levels;
taking a first action with respect to the first set of parameters if the activity falls within a first level and taking a second action with respect to the first set of parameters if the activity falls within a second level.
